(19) United States
(12) Patent Application Publication
(10) Pub. No.: US 2020/0158256 A1
(43) Pub. Date: May 21, 2020

(54) Clamp with State Signal

(71) Applicant: The United States Government as Represented by the Department of Veterans Affairs, Washington, DC (US)

(72) Inventors: Gary Goldish, Minneapolis, MN (US); Gregory O. Voss, Apple Valley, MN (US); Stuart R. Fairhurst, Minneapolis, MN (US)

(21) Appl. No.: 16/683,513

(22) Filed: Nov. 14, 2019

Related U.S. Application Data
(60) Provisional application No. 62/767,596, filed on Nov. 15, 2018.

(51) Int. Cl. F16K 37/00; F16K 7/06

(52) U.S. Cl. CPC F16K 37/0041; F16K 7/066

(57) ABSTRACT

A clamp for controlling fluid flow through a flexible tube has an electrically powered signal generator which can indicate the state of the clamp (closed or open) and thus indicate the state of fluid flow. Momentary switches controlling the signal generator provide versatility to the clamp. Visual, auditory and haptic signals are generated by the signal generator in response to a particular state of the clamp.

### CROSS REFERENCE TO RELATED APPLICATION

This application is based upon and claims priority to U.S. Provisional Application No. 62/767,596, filed Nov. 15, 2018 and hereby incorporated by reference.

### FIELD OF THE INVENTION

The invention concerns clamps for controlling fluid flow through tubes.

### BACKGROUND

When medications are delivered intravenously it is advantageous if all medications are delivered through a single intravenous (IV) extension tube so that patients are not subject to a separate needle for each IV medication delivered. For IV delivery, a primary tube is connected to the extension tube (which is connected to the needle) and runs to a primary bag of IV fluid. The primary tube has one or more bifurcation ports located between the extension tube and the primary bag. The bifurcation ports provide two branches, one branch communicates with the primary IV bag, and other branch allows a clinician to connect a secondary IV bag to the primary tube using a secondary tube for delivery of secondary IV fluid to the patient via the single extension tube. The secondary tube is usually clamped shut during setup to avoid a loss of medication. After the secondary tube has been connected into the primary tube via the bifurcation port, the clamp may be disengaged to allow the medication from the secondary IV bag to flow through the secondary tube, into the primary tube, and to the patient.

IV delivery of medications may be gravity fed or via an infusion pump positioned between the primary tube and the extension tube. Modern IV infusion pumps have the ability to detect if an IV fluid is flowing. However, the fluid flow detection in the infusion pump cannot detect flow issues in secondary lines in the IV system. If a secondary IV line is connected to the primary tube above the infusion pump, the pump is unable to discern if the secondary fluid is flowing or not because the secondary fluid is mixed with primary IV fluid. Alternatively, if the secondary line is connected below the infusion pump, the flow in the secondary line bypasses the flow sensor in the infusion pump altogether.

Because each IV tube may have a clamp, one solution to the problem of determining if secondary fluid is flowing is to incorporate a signal generator into the clamp itself. The signal generator generates a signal indicative of the clamp status (open or closed) and is activated by clamping or unclamping the clamp itself. A clinician may thus receive feedback defining the state of the clamp, either closed or open, and therefore be able to determine when set up of the secondary tube is complete.

### SUMMARY

The invention concerns a clamp for pinching a flexible tube to control fluid flow therethrough. In an example embodiment the clamp comprises a first body defining a hollow for receiving the tube. A second body is mounted on the first body and movable relatively thereto into a configuration wherein the tube is compressed. An electrical circuit is mounted on one of the first and second bodies. In an example embodiment, the circuit comprises a switch operating between the first and second bodies for opening and closing the circuit in response to the configuration and an electrically actuated signal generator mounted on one of the first and second bodies. The signal generator is actuated when the circuit is closed. A power supply is mounted on one of the first and second bodies for supplying power to the signal generator.

In an example embodiment, the power supply comprises an electrical battery and the signal generator comprises a light source. By way of example the light source may comprise a light emitting diode. Further by way of example the signal generator may comprise a noise source, for example a buzzer. In another example, the signal generator may comprise a haptic feedback generator, for example, a vibratory motor.

In an example embodiment the switch may comprise a first electrical contact mounted on the first body and a second electrical contact mounted on the second body. The second electrical contact engaging the first electrical contact closes the circuit when the second body is moved relatively to the first body into the configuration compressing the tube. In another example embodiment the switch comprises a momentary switch mounted on one of the first and second bodies. The momentary switch is thrown by engagement between the switch and one of the first and second bodies when the second body is moved relatively to the first body into the configuration compressing the tube. By way of example the momentary switch may be a push to make type switch or a push to break type switch.

In an example embodiment the signal generator may be selected from the group consisting of a light source, a noise source, a haptic feedback generator and combinations thereof.

In one example embodiment the first body comprises a housing defining an elongate channel comprising two sidewalls connected to one another by a back wall. The tube is received within the channel. In this example the second body comprises a roller movable within the channel between a first position distant from the back wall to a second position proximate to the back wall. The tube is positioned between the roller and the back wall. The roller is in the configuration compressing the tube against the back wall when moved to the second position proximate to the back wall.

In another example embodiment the switch comprises first and second electrical contacts mounted on the housing. A third electrical contact is mounted on the roller. The third electrical contact engages the first and second electrical contacts, thereby closing the circuit, when the roller is moved relatively to the housing into the configuration compressing the tube. By way of example the switch may comprise a momentary switch mounted on the housing. The roller may engage the momentary switch when moved into the configuration compressing the tube against the back wall. Further by way of example the switch may comprise a momentary switch mounted on the housing. The roller may engage the momentary switch when moved away from the configuration compressing the tube against the back wall.

In another example embodiment, the first body comprises a first mandible having a first tooth projecting therefrom and a latch positioned distally to the first tooth. In this example embodiment, the second body comprises a second mandible mounted on the first mandible. A second tooth is mounted on the second mandible in facing relation with the first tooth. The tube is positioned between the first and second teeth, the second mandible is engageable with the latch when the second mandible is moved into the configuration compressing the tube between the first and second teeth.

By way of example the switch may comprise a first electrical contact mounted on the first mandible and second and third electrical contacts mounted on the second mandible. The second and third electrical contacts engage the first electrical contact, thereby closing the circuit, when the second mandible engages the latch. In a further example embodiment the switch may comprise a momentary switch mounted on one of the first and second mandibles. One of the first and second mandibles may engage the momentary switch when moved into the configuration compressing the tube between the first and second teeth.

In another example embodiment the first body comprises a housing defining a clutch adapted to engage and hold the tube. In this embodiment the second body may comprise a pinch plate having a slot therein. The slot has a first region with a width greater than or equal to a diameter of the tube, and a second region having a width less than the diameter of the tube. The pinch plate is movable relatively to the housing between a first position, wherein the tube engages the first region of the slot, and a second position, wherein the tube engages the second region of the slot.

In an example embodiment the switch may comprise first and second electrical contacts mounted on the housing and a third electrical contact mounted on the pinch plate. In this example the third electrical contact engages the first and second electrical contacts, thereby closing the circuit, when the pinch plate is moved relatively to the housing into the second position wherein the tube engages the second region of the slot.

By way of example the switch may comprise a momentary switch mounted on the housing, the pinch plate engaging the momentary switch when moved relatively to the housing into the second position wherein the tube engages the second region of the slot. In another example the switch may comprise a momentary switch mounted on the housing, the pinch plate engaging the momentary switch when moved relatively to the housing into the first position wherein the tube engages the first region of the slot.

### BRIEF DESCRIPTION OF THE DRAWINGS

FIG. 1 is an isometric view of an example embodiment of a roller clamp according to the invention;

FIG. 2 is an isometric view of a component of the clamp shown in FIG. 1;

FIG. 3 is an exploded isometric view of the roller clamp shown in FIG. 1;

FIG. 4 is a partial exploded isometric view of another example embodiment of a roller clamp according to the invention;

FIG. 5 is an isometric view of an example embodiment of a pinch clamp according to the invention;

FIG. 6 is an isometric view of a portion of the pinch clamp shown in FIG. 5 on an enlarged scale;

FIG. 7 is a side view of another example embodiment of a pinch clamp according to the invention;

FIG. 8 is an isometric view of an example embodiment of a clamp according to the invention;

FIG. 9 is an exploded isometric view of the clamp shown in FIG. 8; and

FIGS. 10 and 11 are plan views showing the clamp of FIG. 8 in operation.

### DETAILED DESCRIPTION

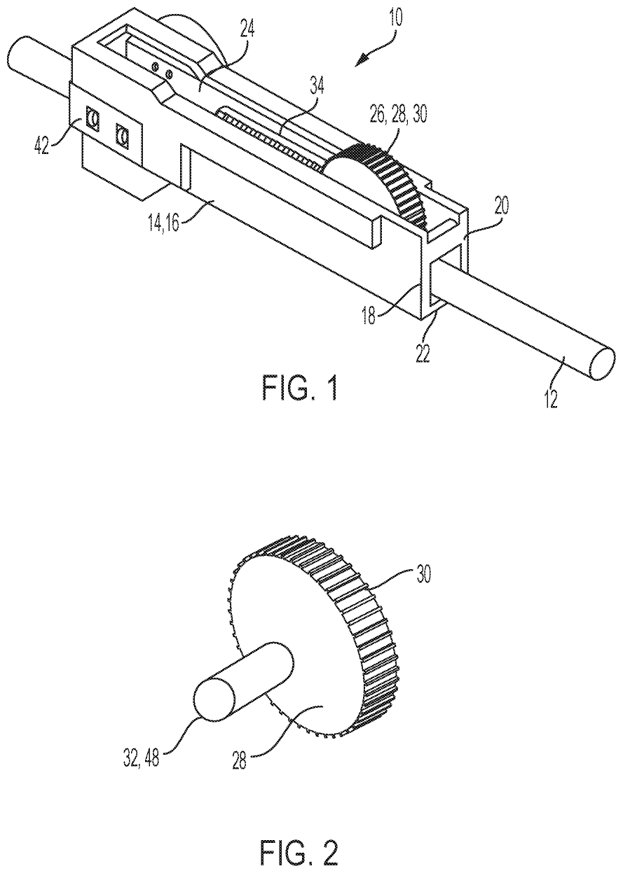

FIG. 1 shows an example embodiment of a clamp 10 for pinching a flexible tube 12 to control fluid flow through the tube. Clamp 10 comprises a first body 14, in this example a housing 16. Housing 16 has sidewalls 18 and 20 connected to one another by a back wall 22 and thereby defining a hollow in the form of an elongate channel 24. Tube 12 is received within the channel 24. A second body 26 is mounted on the first body 14. In this example embodiment the second body 26 comprises a roller 28 movable lengthwise within the channel 24. Roller 28 is shown in detail in FIG. 2 and comprises a knurled wheel 30 mounted on an axle 32. Axle 32 rides within grooves 34 in each sidewall 18 and 20 (see FIG. 1), the perimeter of the wheel 30 engaging the tube 12, and the grooves 34 retaining the wheel within the channel 24 and guiding is motion lengthwise therealong as the wheel is rotated by the thumb of a user. The back wall 22 and grooves 34 are angularly oriented relative to one another such that the roller 28 will compress the tube 12 against the back wall 22 as it moves along the channel 24 between a first position where the roller 28 is distant from the back wall 22, to a second position (shown) where the roller is proximate to the back wall. Compressing the tube 12 against the back wall 22 pinches the tube and thereby controls the flow of fluid therethrough.

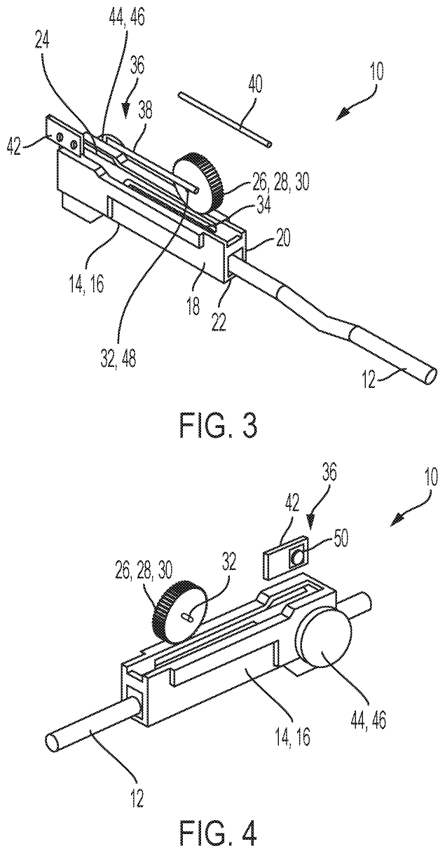

As shown in the exploded view of FIG. 3, clamp 10 comprises an electrical circuit 36 mounted, in this example, on the first body, housing 16. Circuit 36 is formed of first and second electrical contacts 38 and 40 which provide electrical connection to an electrically actuated signal generator 42, and a power supply 44, in this example an electrical battery 46. Both the signal generator 42 and the battery 46 are mounted on the housing 16. A third electrical contact 48 is formed by axle 32 of roller 28 (see also FIG. 2). Contacts 38 and 40 are arranged in cooperation with the electrically conductive axle 32 such that the axle (being contact 48) acts as a switch and engages the first and second electrical contacts 38 and 40, thereby closing the circuit and allowing the battery 46 to power the signal generator 42 when the roller 28 is moved relatively to housing 16 into the position where the roller 28 compresses the tube 12. The signal generated is thus indicative of the flow through the tube being stopped. The signal generator could comprise, for example, a light source, such as one or more light emitting diodes to provide a visual signal, a noise source such as a buzzer to provide an audible signal, a haptic feedback generator, such as a vibratory motor to provide a tactile signal, or a combination of these elements.

FIG. 4 shows another example embodiment of clamp 10 which uses a momentary switch 50 to activate or deactivate the signal generator 42. Momentary switch 50 is part of the circuit 36 connecting the power supply 44 (battery 46) and the signal generator 42. Momentary switch 50 may be of the “press to make” type, meaning that the switch is normally open and closes when pressed, or the “press to break” type, which means the switch is normally closed and opens when pressed. The roller 28 serves as the actuating element and will press or release the momentary switch 50 as it is moved relatively to the housing 16. With a two position roller 28 and two types of momentary switches 50 the invention provides for a versatile clamp design, as the switch can be positioned on the housing to be pressed by the roller in either position (tube open or tube closed) and the type of switch selected (press to make or press to break) means that the signal generator can indicate an open tube (fluid flow) or a closed tube (no fluid flow) either by displaying a signal (visual, auditory, haptic or combination), or not displaying a signal.

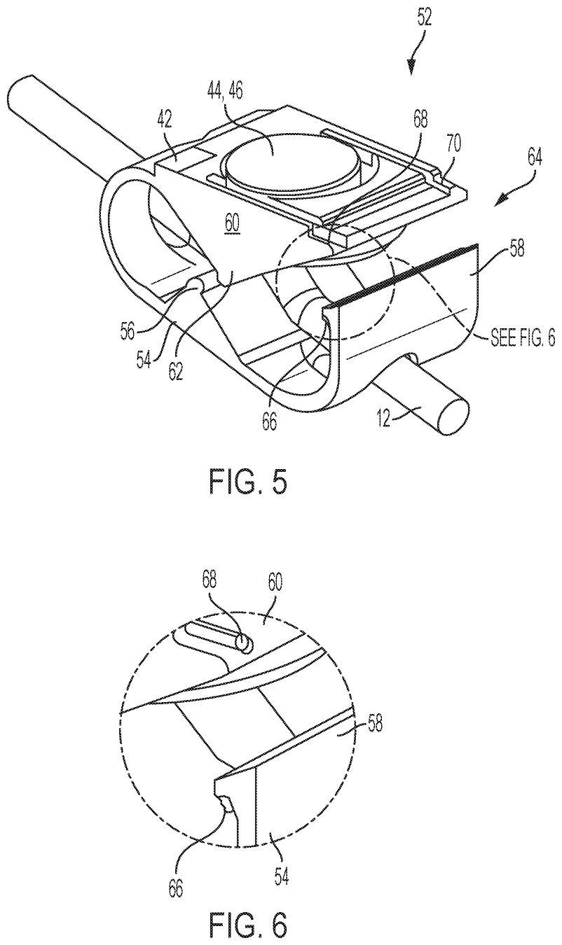

FIG. 5 shows another example embodiment of a clamp 52 according to the invention. Clamp 52 comprises a first mandible 54 having a first tooth 56 projecting therefrom. A latch 58 is also positioned on the first mandible distally to the tooth 56. A second mandible 60 is mounted on the first mandible 54. In this example the second mandible 60 is integrally formed with the first mandible 54. A second tooth 62 is mounted on the second mandible 60 and is positioned in facing relation with the first tooth 56 such that the tube 12 is positioned between and may be compressed by the first and second teeth when the mandibles are moved toward one another. The clamp 52 is advantageously formed from a flexible, resilient material and is normally resiliently biased in the open configuration (shown) where the tube 12 is not pinched. The second mandible 60 is engageable with the latch 58 to hold the mandibles in a closed position, pinching the tube 12 closed. The second mandible 60 may be released to resiliently snap back into the open position by deflecting the first mandible 54 and disengaging the latch 58.

As further shown in FIG. 5, the clamp 52 also comprises an electrical circuit 64 wherein a first electrical contact 66 is mounted on the first mandible 54 and second and third electrical contacts 68 and 70 are mounted on the second mandible 60. The circuit connects a power supply 44, again a battery 46 mounted on the second mandible 60 with a signal generator 42, also mounted on the second mandible in this example. As may be deduced from FIGS. 5 and 6, when the second mandible 60 is moved toward the first mandible 54 and into engagement with the latch 58, the first, second and third contacts are in engaged, thereby forming a switch which is closed and which activates the signal generator 42. Signal generator 42 then indicates that the tube 12 is closed (no fluid flow) through its signal mode (visual, auditory, haptic, or combination).

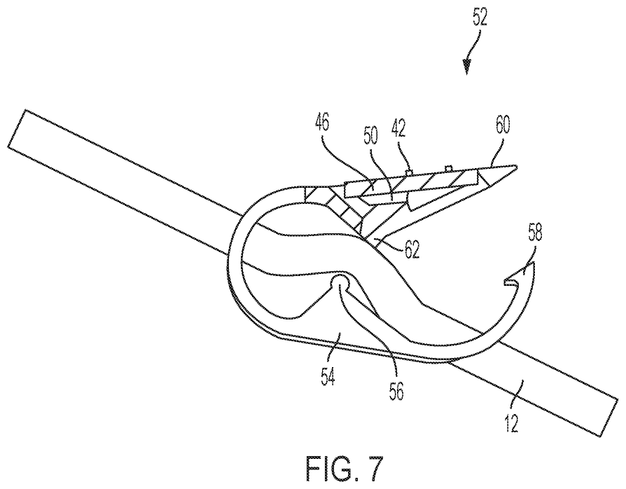

FIG. 7 shows clamp embodiment 52 using a momentary switch 50 to open and close circuit 64 and thereby activate or deactivate the signal generator 42. Momentary switch 50 is positioned between the second tooth 62 and the second mandible 60. The second tooth 62 is cantilevered from the second mandible 60 and thus the tooth will flex relatively to the mandible when it is subject to compression as it engages tube 12, pinching it against the first tooth 56. Versatility is afforded to the design with the use of the momentary switch 50, as it can be a press to make type switch, where a signal would indicate a closed tube 12 (no flow) or a press to break type switch, where the absence of a signal would indicate a closed tube 12 and no flow.

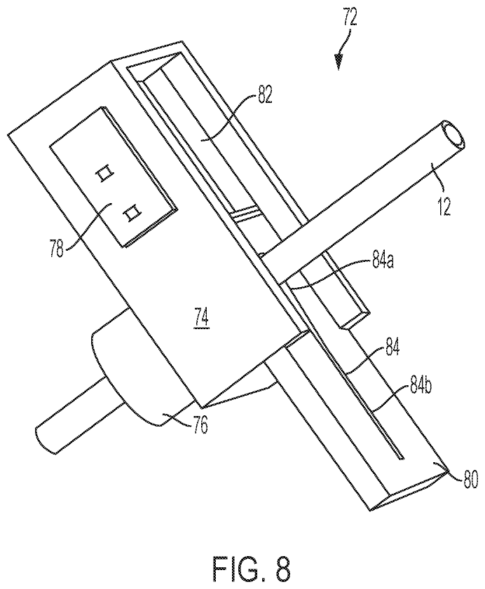

FIG. 8 shows a clamp embodiment 72 wherein the first body comprises a housing 74, the housing defining a hollow in the form of a clutch 76 which engages and holds the flexible tube 12 to the housing. In this example, the clutch 76 comprises a collar having an inner diameter about the same size as the outer diameter of the tube, and engagement between the clutch 76 and tube 12 is via friction between contacting surfaces of the tube and clutch. Housing 74 also provides supporting structure for mounting electrically actuated signal generator 78. The signal generator could comprise, for example, a light source, such as one or more light emitting diodes to provide a visual signal, a noise source such as a buzzer to provide an audible signal, a haptic feedback generator, such as a vibratory motor to provide a tactile signal, or a combination of these elements.

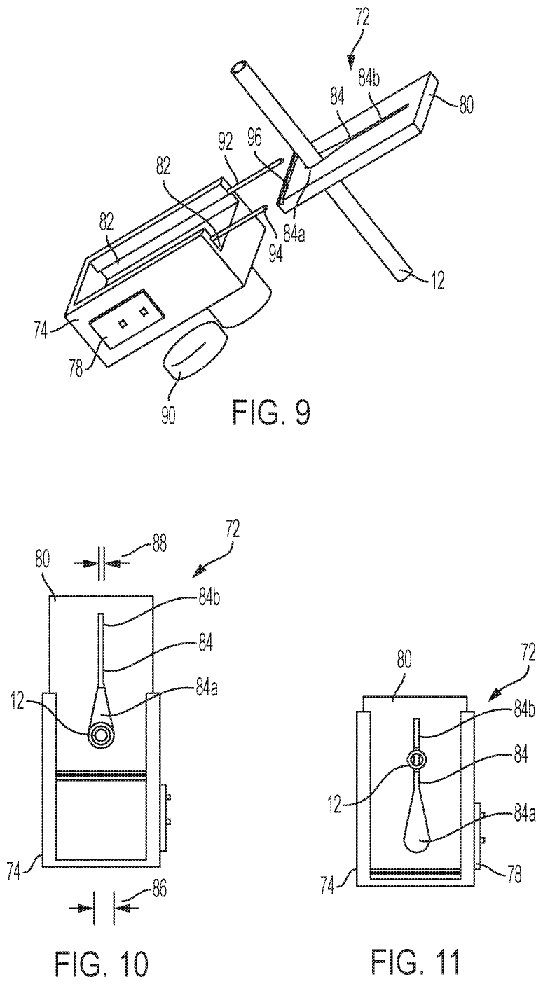

The second body comprises a pinch plate 80. As shown in FIGS. 8 and 9, the pinch plate 80 slides within first and second slots 82 formed in housing 74, thereby allowing the pinch plate to move relatively to the housing and transversely to tube 12. Pinch plate 80 has a slot 84 extending substantially parallel to the direction of sliding motion of the pinch plate. Tube 12, held by clutch 76, passes through slot 84 when clamp 72 is mounted on the tube. Slot 84 has a first region 84a, wherein the width 86 of the slot (see FIG. 10) is greater than or equal to the diameter of tube 12, and a second region 84b, wherein the width 88 is less than the diameter of the tube 12. As shown in FIGS. 10 and 11, pinch plate 80 is movable relatively to housing 74 between a first position (FIG. 10) wherein tube 12 engages the first region 84a of slot 84, and a second position (FIG. 11) wherein tube 12 engages the second region 84b of slot 84. As may be deduced, fluid will flow through tube 12 when pinch plate 80 is in the first position, and flow will be prevented when pinch plate 80 is in the second position.

As shown in FIG. 9, signal generator 78 is powered by a battery 90 mounted on housing 74. Battery 90 is connected to signal generator 78 by an electrical circuit, in this example comprising first and second electrical conductors 92 and 94 mounted on housing 74 and a third electrical conductor 96 mounted on pinch plate 80. Together the conductors comprise a switch 98 which connects the signal generator 78 to battery 90 when it is desired to actuate the signal generator. In this example embodiment the signal generator is actuated (switch closed forming a circuit between signal generator and battery) when the pinch plate is in the second position (FIG. 11). In this switch configuration actuation of the signal generator indicates no flow through tube 12. Other switch configurations are of course possible, and the simple contact switch shown could be replaced by a momentary switch between the pinch plate 80 and housing 74.

It is expected that the use of clamps having a signal generator will improve the safety of intravenous administration of fluids to patients.

What is claimed is:

1. A clamp for pinching a flexible tube to control fluid flow therethrough, said clamp comprising:
a first body defining a hollow for receiving said tube;
a second body mounted on said first body and movable relatively thereto into a configuration wherein said tube is compressed;
an electrical circuit mounted on one of said first and second bodies, said circuit comprising:
a switch operating between said first and second bodies for opening and closing said circuit in response to said configuration;
an electrically actuated signal generator mounted on one of said first and second bodies, said signal generator being actuated when said circuit is closed; and
a power supply mounted on one of said first and second bodies for supplying power to said signal generator.

2. The clamp according to claim 1, wherein said power supply comprises an electrical battery.

3. The clamp according to claim 1, wherein said signal generator comprises a light source.

4. The clamp according to claim 3, wherein said light source comprises a light emitting diode.

5. The clamp according to claim 1, wherein said signal generator comprises a noise source.

6. The clamp according to claim 5, wherein said noise source comprises a buzzer.

7. The clamp according to claim 1, wherein said signal generator comprises a haptic feedback generator.

8. The clamp according to claim 7, wherein said haptic feedback generator comprises a vibratory motor.

9. The clamp according to claim 1, wherein said switch comprises:
a first electrical contact mounted on said first body;
a second electrical contact mounted on said second body;
wherein said second electrical contact engages said first electrical contact, thereby closing said circuit, when said second body is moved relatively to said first body into said configuration compressing said tube.

10. The clamp according to claim 1, wherein said switch comprises a momentary switch mounted on one of said first and second bodies, said momentary switch being thrown by engagement between said switch and one of said first and second bodies when said second body is moved relatively to said first body into said configuration compressing said tube.

11. The clamp according to claim 10, wherein said momentary switch is a push to make type switch.

12. The clamp according to claim 10, wherein said momentary switch is a push to break type switch.

13. The clamp according to claim 1, wherein said signal generator is selected from the group consisting of a light source, a noise source, a haptic feedback generator and combinations thereof.

14. The clamp according to claim 1, wherein said first body comprises:
a housing defining an elongate channel comprising two sidewalls connected to one another by a back wall, said tube being received within said channel; and wherein said second body comprises:
a roller movable within said channel between a first position distant from said back wall to a second position proximate to said back wall, said tube being positioned between said roller and said back wall, said roller being in said configuration compressing said tube against said back wall when moved to said second position proximate to said back wall.

15. The clamp according to claim 14, wherein said switch comprises:
first and second electrical contacts mounted on said housing;
a third electrical contact mounted on said roller; wherein
said third electrical contact engages said first and second electrical contacts, thereby closing said circuit, when said roller is moved relatively to said housing into said configuration compressing said tube.

16. The clamp according to claim 14, wherein said switch comprises a momentary switch mounted on said housing, said roller engaging said momentary switch when moved into said configuration compressing said tube against said back wall.

17. The clamp according to claim 14, wherein said switch comprises a momentary switch mounted on said housing, said roller engaging said momentary switch when moved away from said configuration compressing said tube against said back wall.

18. The clamp according to claim 1, wherein:
said first body comprises a first mandible having a first tooth projecting therefrom and a latch positioned distally to said first tooth; and wherein
said second body comprises a second mandible mounted on said first mandible, a second tooth being mounted on said second mandible in facing relation with said first tooth, said tube being positioned between said first and second teeth, said second mandible being engageable with said latch when said second mandible is moved into said configuration compressing said tube between said first and second teeth.

19. The clamp according to claim 18, wherein said switch comprises:
a first electrical contact mounted on said first mandible;
second and third electrical contacts mounted on said second mandible; wherein
said second and third electrical contacts engage said first electrical contact, thereby closing said circuit, when said second mandible engages said latch.

20. The clamp according to claim 18, wherein said switch comprises a momentary switch mounted on one of said first and second mandibles, one of said first and second mandibles engaging said momentary switch when moved into said configuration compressing said tube between said first and second teeth.

21. The clamp according to claim 1, wherein said first body comprises:
a housing defining a clutch adapted to engage and hold said tube; and wherein said second body comprises:
a pinch plate having a slot therein, said slot having a first region with a width greater than or equal to a diameter of said tube, and a second region having a width less than said diameter of said tube, said pinch plate being movable relatively to said housing between a first position wherein said tube engages said first region of said slot, and a second position wherein said tube engages said second region of said slot.

22. The clamp according to claim 20, wherein said switch comprises:
first and second electrical contacts mounted on said housing;
a third electrical contact mounted on said pinch plate; wherein
said third electrical contact engages said first and second electrical contacts, thereby closing said circuit when said pinch plate is moved relatively to said housing into said second position wherein said tube engages said second region of said slot.

23. The clamp according to claim 21, wherein said switch comprises a momentary switch mounted on said housing, said pinch plate engaging said momentary switch when moved relatively to said housing into said second position wherein said tube engages said second region of said slot.

24. The clamp according to claim 21, wherein said switch comprises a momentary switch mounted on said housing, said pinch plate engaging said momentary switch when moved relatively to said housing into said first position wherein said tube engages said first region of said slot.
